(19) United States
(12) Patent Application Publication
(10) Pub. No.: US 2012/0200286 A1
(43) Pub. Date: Aug. 9, 2012

(54) RESOLVER

(75) Inventors: Hisashi KINO, Ichinomiya-shi (JP); Kazuhiro NAKAMURA, Ichinomiya-shi (JP); Shinya SUZUKI, Obu-shi (JP)

(73) Assignee: AISAN KOGYO KABUSHIKI KAISHA, Obu-shi (JP)

(21) Appl. No.: 13/363,703

(22) Filed: Feb. 1, 2012

(30) Foreign Application Priority Data
Feb. 9, 2011 (JP) 2011-025909

(51) Int. Cl. G01B 7/30

(52) U.S. Cl. 324/207.16

(57) ABSTRACT

A SIN signal detection coil is divided into two parts in a circumferential direction and further into two parts in a radial direction so that a SIN-coil first part and a SIN-coil second part are arranged on an outer circumferential side and a SIN-coil third part and a SIN-coil fourth part are arranged on an inner circumferential side. The SIN-coil first part and third part are placed in the same position in the circumferential direction and to face each other in a radial direction. The SIN-coil second part and fourth part are placed in the same position in the circumferential direction and to face each other in the radial direction. The SIN-coil first part and fourth part are placed in the first coil layer. The SIN-coil second part and third part are placed in the second coil layer.

### CROSS-REFERENCE TO RELATED APPLICATIONS

This application is based upon and claims the benefit of priority from the prior Japanese Patent Application No. 2011-025909, filed on Feb. 9, 2011, the entire contents of which are incorporated herein by reference.

### TECHNICAL FIELD

The present invention relates to a resolver including a SIN coil and a COS coil each formed on a flat plate so that a first coil layer and a second coil layer are each formed on the flat plate and an insulation layer is formed between the first coil layer and the second coil layer.

### BACKGROUND ART

In a hybrid electric vehicle and an electric vehicle, high-power brushless motors are adopted. Further, higher-power brushless motors will be expected in the future. To control a brushless motor of a hybrid electric vehicle, it is necessary to detect a precise rotation angle of an output shaft of the motor. This is because a rotation position (angle) of a rotor has to be detected accurately to control changeover of energization of coils of a stator.

Accordingly, a motor is desired to include a resolver to detect an accurate angle. A resolver to be used in a drive mechanism of a vehicle is demanded to achieve higher accuracy in consideration of the large number of rotations of the drive mechanism as well as environment resistance and others. Further, the resolver, as with other in-vehicle components, is also demanded to reduce size and cost.

The applicant of the present application proposed a high-accurate resolver in Patent Document 1. Specifically, this resolver includes a SIN coil and a COS coil each formed on a flat plate. Further, a first coil layer and a second coil layer are formed on the flat plate and an insulation layer is formed between the first and second coil layers. The SIN coil includes a SIN-coil first part formed in a first coil layer and a SIN-coil second part formed in a second coil layer. The COS coil includes a COS-coil first part formed in the first coil layer and a COS-coil second part formed in the second coil layer. With this configuration, even when a gap between an excitation coil and a detection coil varies, which could be caused when the resolver is mounted in a motor of a vehicle and others, the resolver can maintain high detection accuracy.

### RELATED ART DOCUMENTS

### Patent Documents

Patent Document 1: JP 2010-237077A

### DISCLOSURE OF THE INVENTION

### Problems to be Solved by the Invention

However, the technique disclosed in Patent Document 1 has the following disadvantages. Specifically, the resolver of Patent Document 1 could provide high accuracy even if a distance between an excitation coil flat plate and a detection coil fiat plate varies when the resolver is mounted in the motor and others. If the excitation coil flat plate and the detection coil flat plate are deformed circumferentially, such as undulating (irregularity in flatness), some errors are likely found in detection results, leading to low accuracy. To be concrete, if the gap changes due to the undulating or other deformation in the circumferential direction, a magnetic flux density applied to the detection coil changes, causing errors in induced voltage which is generated in the coil. This results in errors in detection angle.

The present invention has been made in view of the circumstances to solve the above problems and has a purpose to provide a resolver capable of providing high accuracy even when an excitation coil flat plate and a detection coil flat plate themselves are deformed, e.g., undulated, in a circumferential direction.

### Means of Solving the Problems

(1) To achieve the above purpose, one aspect of the invention provides a resolver having a SIN coil and a COS coil each formed on a flat plate, the resolver including a first coil layer and a second coil layer each formed on the flat plate, and an insulation layer formed between the first coil layer and the second coil layer, wherein the SIN coil is divided into two parts in a circumferential direction and further two parts in a radial direction so that a SIN-coil first part and a SIN-coil second part are arranged on an outer circumferential side and a SIN-coil third part and a SIN-coil fourth part are arranged on an inner circumferential side, the SIN-coil first part and the SIN-coil third part are arranged in the same position in the circumferential direction and to face each other in a radial direction and the SIN-coil second part and the SIN-coil fourth part are arranged in the same position in the circumferential direction and to face each other in the radial direction, the SIN-coil first part and the SIN-coil fourth part are placed in the first coil layer and the SIN-coil second part and the SIN-coil third part are placed in the second coil layer, the COS coil is divided into two parts in the circumferential direction and further into two parts in the radial direction so that a COS-coil first part and a COS-coil second part are arranged on an outer circumferential side and a COS-coil third part and a COS-coil fourth part are arranged on an inner circumferential side, the COS-coil first part and the COS-coil third part are arranged in the same position in the circumferential direction and to face each other in the radial direction and the COS-coil second part and the COS-coil fourth part are in the same position in the circumferential direction and to face each other in the radial direction, and the COS-coil first part and the COS-coil fourth part are placed in the first coil layer, and the COS-coil second part and the COS-coil third part are placed in the second coil layer.

With the above configuration, even when a flat plate on which the SIN coil and the COS coil are formed is deformed, e.g., undulated, in a circumferential direction, the SIN-coil first part (SIN-coil fourth part) and the SIN-coil second part (SIN-coil third part) cancel or compensate the errors generated by deformation such as undulating and similarly the COS-coil first part (COS-coil fourth part) and the COS-coil second part (COS-coil third part) cancel the errors generated by deformation such as undulating. Thus, the resolver can achieve high accuracy.

Specifically, the SIN-coil first part is in the first coil layer, the SIN-coil second part is in the second coil layer, the SIN-coil third part is in the second coil layer, and the SIN-coil fourth part is in the first coil layer. Accordingly, when the SIN-coil first and fourth parts in the first coil layer receive a magnetic flux density different from that the SIN-coil second and third parts in the second coil layer receive due to a gap which changes by the circumferential deformation, the SIN coils (SIN-coil first part, SIN-coil second part, SIN-coil third part, and SIN-coil fourth part) can wholly cancel the errors out.

Similarly, the COS-coil first part is in the first coil layer, the COS-coil second part is in the second coil layer, the COS-coil third part is in the second coil layer, and the COS-coil fourth part is in the first coil layer. Accordingly, when the COS-coil first and fourth parts in the first coil layer receive a magnetic flux density different from that the COS-coil second and third parts in the second coil layer receive due to a gap which changes by the circumferential deformation, the COS coils (COS-coil first part, COS-coil second part, COS-coil third part, and COS-coil fourth part) can wholly cancel the errors out.

(2) In the above resolver, preferably, a pair of the SIN-coil first part and the SIN-coil third part and a pair of the COS-coil second part and the COS-coil fourth part are located in the same position in the circumferential direction, and a pair of the SIN-coil second part and the SIN-coil fourth part and a pair of the COS-coil first part and the COS-coil third part are located in the same position in the circumferential direction.

With the above configuration (2), a positional relationship between the SIN coil and the COS coil can be always constant with respect to for example the excitation coil or the detection coil.

(3) In the above resolver described in (1) or (2), preferably, the SIN-coil first part and the SIN-coil second part are connected through a through hole formed in the insulation layer, the SIN-coil second part and the SIN-coil fourth part are connected through the through hole of the insulation layer, the SIN-coil fourth part and the SIN-coil third part are connected through the through hole of the insulation layer, the SIN-coil third part and the SIN-coil first part are connected through the through hole of the insulation layer, the COS-coil first part and the COS-coil second part are connected through the through hole of the insulation layer, the COS-coil second part and the COS-coil fourth part are connected through the through hole of the insulation layer, the COS-coil fourth part and the COS-coil third part are connected through the through hole of the insulation layer, and the COS-coil third part and the COS-coil first part are connected through the through hole of the insulation layer.

With the above configuration (3), the excitation coil can be manufactured easily and with high positional accuracy. Thus, even when the received magnetic flux densities are different due to the gap which changes in the circumferential direction, the SIN coils (SIN-coil first part, SIN-coil second part, SIN-coil third part, and SIN-coil fourth part) can wholly cancel the errors out reliably and accurately.

(4) In the above resolver described in (1) or (2), preferably, each of the first coil layer and the second coil layer is formed by in such a way that a predetermined pattern is drawn by printing with conductive ink and then subjected to burning. Accordingly, even when a deviation is present between the first coil layer and the second coil layer as a result of the burning process, the resolver having the above configuration (1) can average resistance values of the SIN coil and the COS coil respectively, so that the resistance values are canceled each other. This is less likely to deteriorate detection accuracy.

(5) In the above resolver described in (1) or (2), preferably, the SIN coil and the COS coil form a detection coil. Accordingly, the resolver can generate a constant electromotive force (a detection current) with respect to a predetermined magnetic field generated in the excitation coil and thus achieve high accuracy.

### BRIEF DESCRIPTION OF THE DRAWINGS

FIG. 1 is an exploded perspective view of a resolver stator having a surface on which a SIN signal detection coil and a COS signal detection coil are formed;

FIG. 2 is a plan view of a first coil layer of FIG. 1(b);

FIG. 3 is an enlarged view of a SIN-coil first part and a SIN-coil fourth part of FIG. 2;

FIG. 4 is a plan view of a second coil layer of FIG. 1(d);

FIG. 5 is an enlarged view of a SIN-coil third part and a SIN-coil second part of FIG. 4;

FIG. 6 is an exploded perspective view of a resolver rotor;

FIG. 7 is a block diagram showing a control for detecting a position of the resolver; and

FIG. 8 is a cross sectional view simply showing a part of a motor in a first example.

### MODE FOR CARRYING OUT THE INVENTION

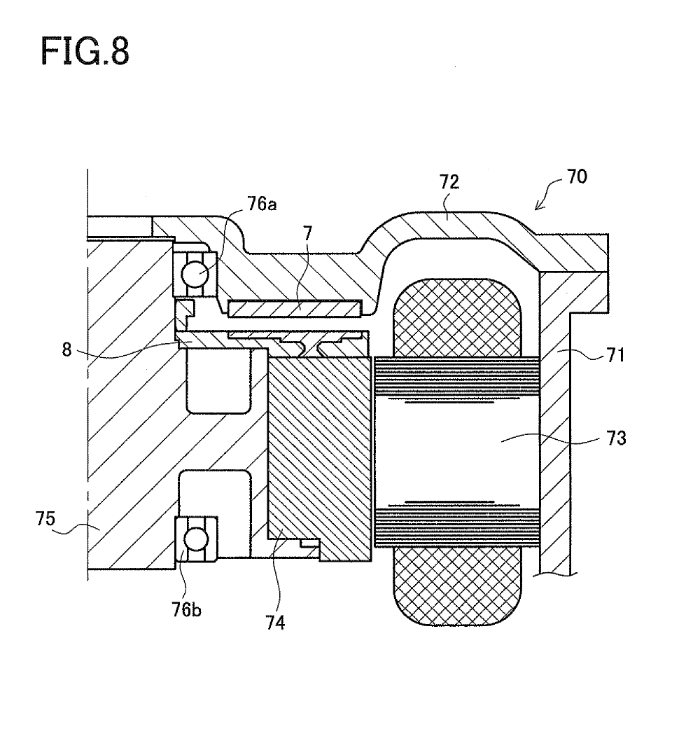

A detailed description of a first example of a resolver embodying the present invention will now be given referring to the accompanying drawings. FIG. 8 is a cross sectional view simply showing a structure of a part of a motor in the first example.

A motor 70 is a brushless motor including a case body 71, a case cover 72, a motor stator 73, a motor rotor 74, a motor shaft 75, and bearings 76a and 76b. The case body 71 and the cover 72 are made of aluminum alloy or the like by casting. The bearing 76b is fixed to the case body 71 and the bearing 76a is fixed to the case cover 72 so that the motor shaft 75 is rotatably supported.

The motor stator 73 is fixed on the inner circumferential surface of the case body 71. This stator 73 has a coil which generates a magnetic force when energized. On the other hand, the motor rotor 74 including a permanent magnet is fixed on the motor shaft 75. The stator 73 and the rotor 74 are held apart at a predetermined distance. When a current is applied to the stator 73, the rotor 74 is rotated, generating a driving force which is transmitted as power to the shaft 75.

A resolver stator 7 is fixed to the case cover 72, while a resolver rotor 8 is fixed to the motor rotor 74, so that the resolver stator 7 and the resolver rotor 8 are spaced from each other by a predetermined distance when the case body 71 and the cover 72 are assembled together. As the predetermined distance is shorter, a resolver 9 can provide higher detection accuracy. However, the predetermined distance is determined in consideration of dimensional tolerances, dimensional changes depending on temperatures, and others.

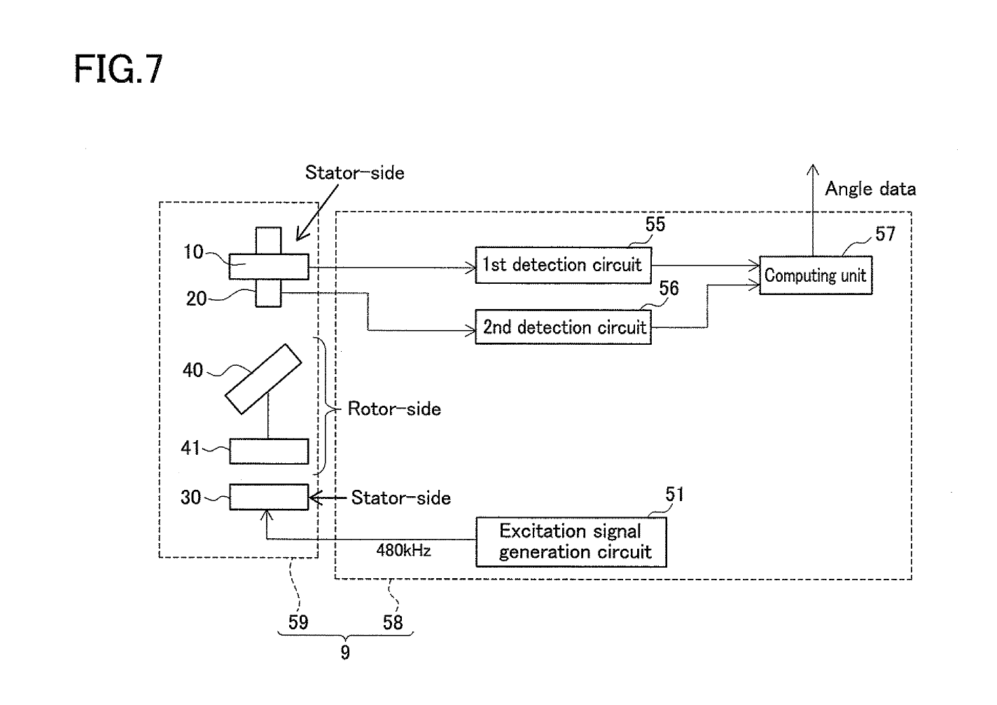

FIG. 7 is a block diagram showing a control for detecting the position of the resolver. The resolver 9 includes a circuit 58 and a sensor section 59. The circuit 58 includes an excitation signal generation circuit 51, a first detection circuit 55, a second detection circuit 56, and a computing unit 57. The sensor section 59 includes a SIN signal detection coil 10, a COS signal detection coil 20, an excitation coil 40, a rotor-side rotary transformer 41, and a stator-side rotary transformer 30. The excitation signal generation circuit 51 arranged to generate a SIN signal wave of 480 kHz is connected to the stator-side rotary transformer 30 as shown in FIG. 7.

The first detection circuit 55 connected to the SIN signal detection coil 10 and the detection circuit 56 connected to the COS signal detection coil 20 are respectively connected to the computing unit 57. The excitation coil 40 is connected to the rotor-side rotary transformer 41.

Each configuration of the SIN signal detection coil 10 and the COS signal detection coil 20 will be explained in detail below.

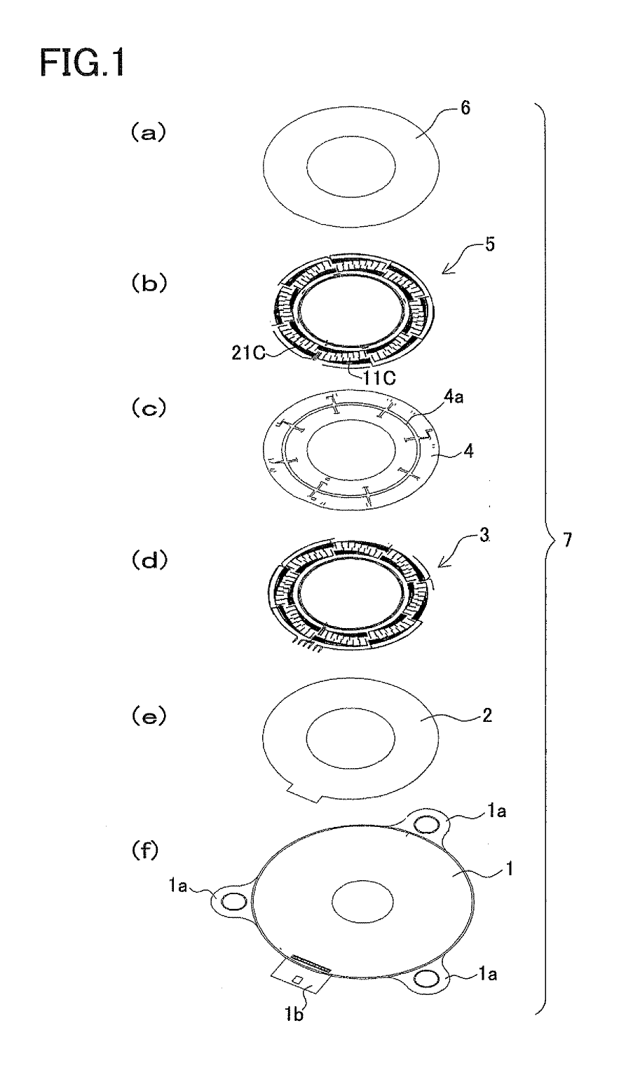

FIG. 1 is an exploded perspective view of the resolver stator 7 with a surface on which the SIN signal detection coil 10 and the COS signal detection coil 20 are formed. In FIG. 1, (f) shows a resolver body 1 which is a substrate made of PPS resin to have high planarity; (e) shows an insulation film layer 2; (d) shows a second coil layer 3 formed on a surface of the insulation film layer 2; (c) shows an insulation layer 4 that insulates between a first coil layer 5 and the second coil layer 3; (b) shows the first coil layer 5 formed on the 2 5 insulation layer 4; and (a) shows an overcoat layer 6 made of insulation resin serving as a protective film.

As shown in FIG. 1(f), the resolver body 1 has a circular disk form with a central circular hole and is provided with three mounting parts 1 a each of which extends radially outwardly and a single terminal part 1b.

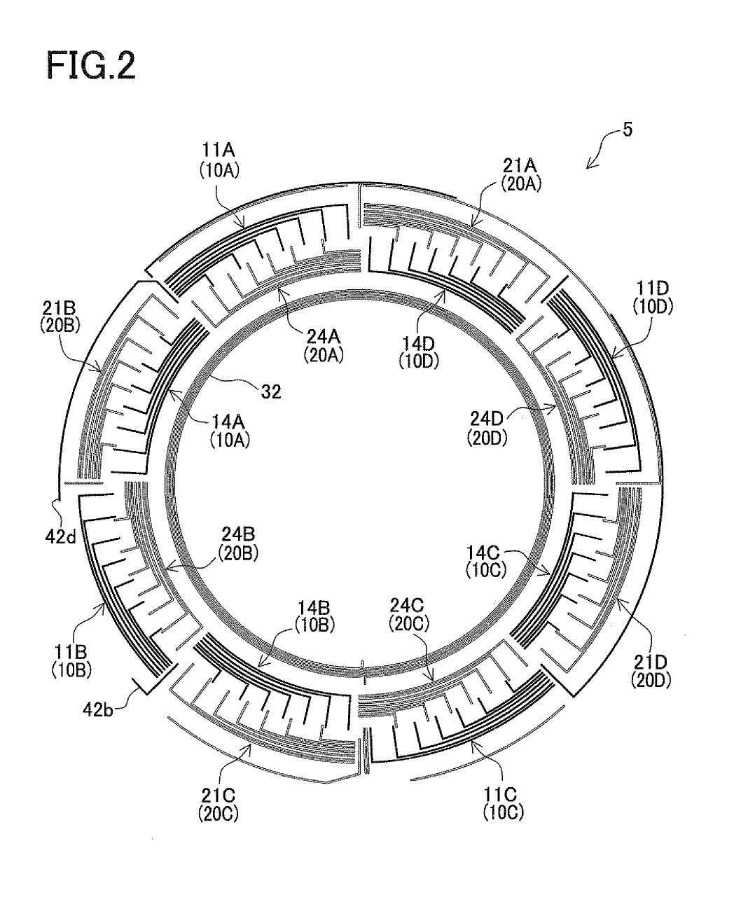

FIG. 2 is a plan view of the first coil layer 5 of FIG. 1(b). A coil pattern of the first coil layer 5 is formed in such a way that the pattern is drawn by printing on a surface of the insulation film layer 2 with electrically conductive ink and then subjected to burning. The SIN signal detection coil 10 thus includes four coils (10A-10D) arranged in order with a displacement of 90° in phase from each other and each of the coils (10A-10D) is divided into two parts in a circumferential direction and also two parts in a radial direction.

Accordingly, in the SIN signal detection coil 10, four SIN-coil first parts 11A, 11B, 11C, and 11D are arranged on an outer circumferential side in the first coil layer 5 and at different positions with a displacement of 90° in turn and four SIN-coil fourth parts 14A, 14B, 14C and 14D are arranged on an inner circumferential side and at different positions with a displacement of 90° in turn. The SIN-coil fourth parts 14A to 14D are displaced respectively from the SIN-coil first parts 11A to 11D at a clockwise displacement of 45° in phase.

On the inner circumferential sides of the SIN-coil first parts 11A to 11D, COS-coil fourth parts 24A, 24B, 24C, and 24D are respectively arranged. Further, on the outer circumferential side of the SIN-coil fourth parts 14A to 14D, COS-coil first parts 21B, 21C, 21D, and 21A are arranged correspondingly. An intermediate position between the COS-coil first part 21C and the SIN-coil first part 11C coincides with the center line of the terminal part 1b.

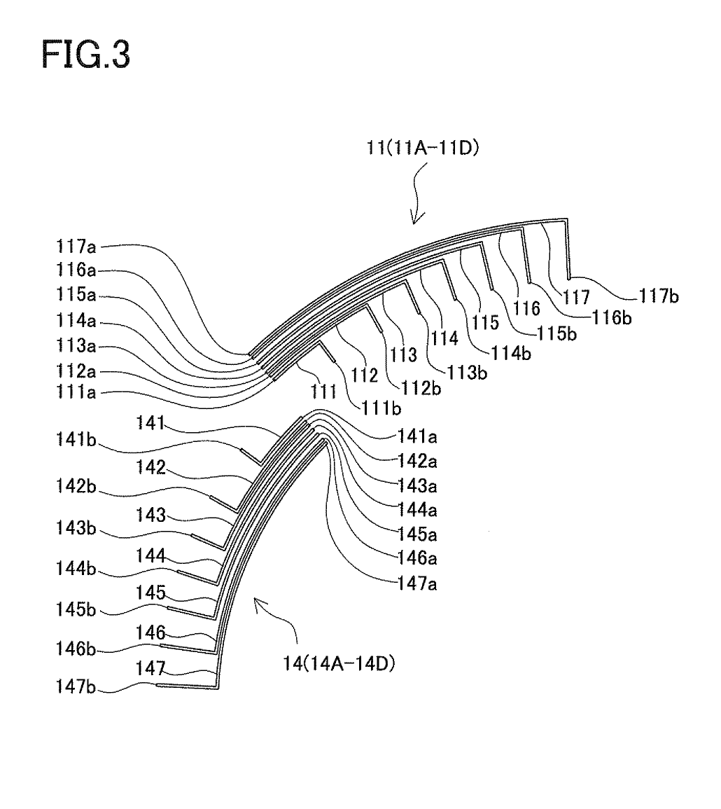

FIG. 3 is an enlarged view of the SIN-coil first part 11 (11A, 11B, 11C, or 11D) and the SIN-coil fourth part 14 (14A, 14B, 14C, or 14D) alone of FIG. 2. The patterns in FIG. 2 are illustrated by solid black lines, but the patterns in FIG. 3 are illustrated by hollow lines.

The SIN-coil first part 11 includes seven coil wires 111, 112, 113, 114, 115, 116, and 117 constituting a quarter section of an almost rectangular or sector form of each coil 10A-10D. The coil wires 111 to 117 are arranged in sequence from the inner circumferential side of each coil to the outer circumferential side.

Similarly, the SIN-coil fourth part 14 includes seven coil wires 141, 142, 143, 144, 145, 146, and 147 constituting a quarter section of an almost rectangular or sector form of each coil 10A-10D. The coil wires 141 to 147 are arranged in sequence from the inner circumferential side of each coil to the outer circumferential side.

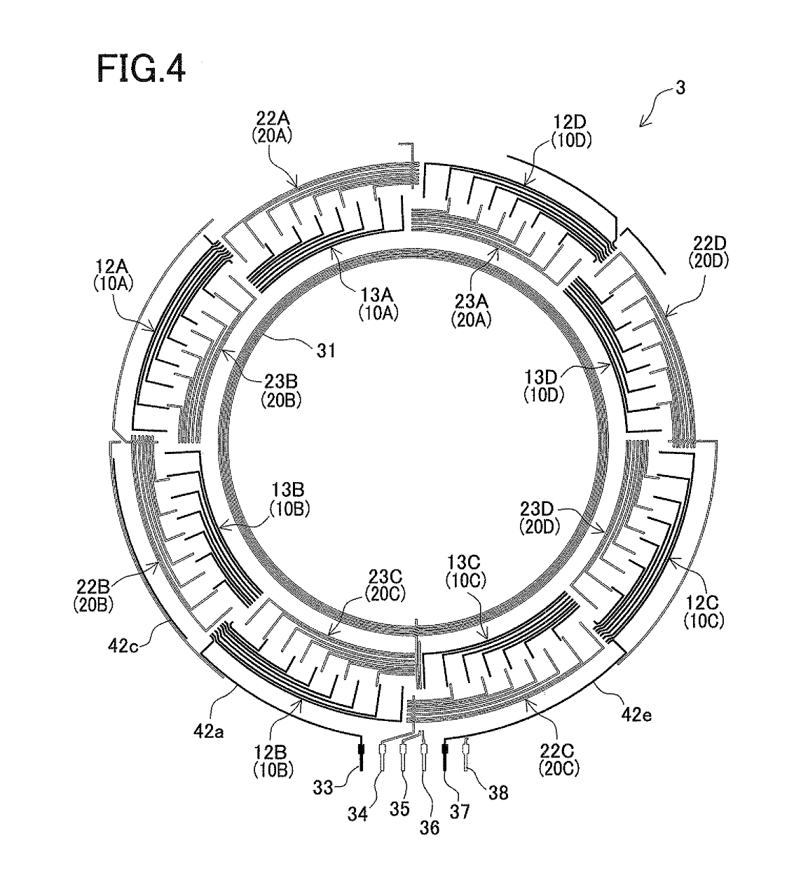

FIG. 4 is a plan view of the second coil layer 3 of FIG. 1(d). A coil pattern of the second coil layer 3 is formed in such a way that the pattern is drawn by printing on a surface of the insulation layer 4 with electrically conductive ink and then subjected to burning. The SIN signal detection coil 10 thus includes four coils (10A-10D) arranged with a displacement of 90° in phase from each other and each of the coils (10A-10D) is divided into two parts in the circumferential direction and also two parts in the radial direction.

Accordingly, four SIN-coil second parts 12A, 12B, 12C, and 12D are arranged on an outer circumferential side in the second coil layer 3 at different positions with a displacement of 90° in turn and four SIN-coil third parts 13A, 13B, 13C, and 13D are arranged on an inner circumferential side at different positions with a displacement of 90°. The SIN-coil third parts 13A to 13D are displaced respectively from the SIN-coil second parts 12A to 12D at a clockwise displacement of 45° in phase. Further, on the inner circumferential side of the SIN-coil second parts 12A to 12D, COS-coil third parts 23A, 23B, 23C, and 23D are respectively arranged. On the outer circumferential side of the SIN-coil third parts 13A to 13D, COS-coil second parts 22A, 22B, 22C, and 22D are arranged.

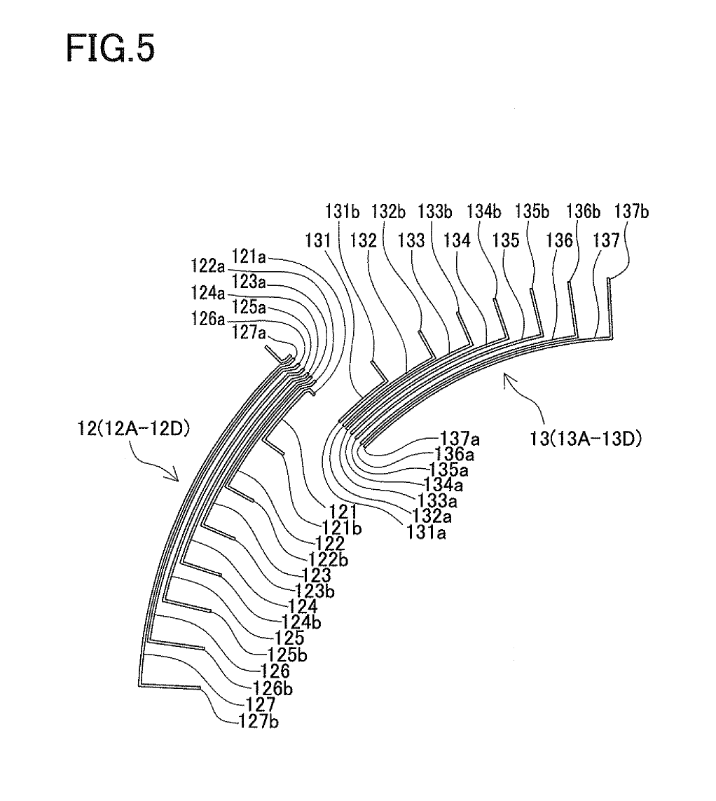

FIG. 5 is an enlarged view of the SIN-coil third part 13 (13A, 13B, 13C, or 13D) and the SIN-coil second part 12 (12A, 12B, 12C, or 12D) alone of FIG. 4.

The SIN-coil second part 12 includes seven coil wires 121, 122, 123, 124, 125, 126, and 127 constituting a quarter section of an almost rectangular or sector form of each coil 10A-10D. The coil wires 121 to 127 are arranged in sequence from the inner circumferential side of each coil to the outer circumferential side.

Similarly, the SIN-coil third part 13 includes seven coil wires 131, 132, 133, 134, 135, 136, and 137 a quarter section of an almost rectangular or sector form of each coil 10A-10D. The coil wires 131 to 137 are arranged in sequence from the inner circumferential side of each coil to the outer circumferential side.

Referring to FIGS. 1 to 4, the configuration of the SIN signal detection coil 10 is explained below. As shown in FIG. 4, the SIN signal detection coil 10 has terminals 33 and 37.

The terminal 33 shown in FIG. 4 is connected to an end 117a of the coil wire 117 of the SIN-coil first part 11B shown in FIG. 2 through a conductive wire 42a and a through hole 4a formed in the insulation layer 4. The other end 117b of the coil wire 117 is connected to an end 137b of the coil wire 137 of the SIN-coil third part 13B shown in FIG. 4 through the through hole 4a of the insulation layer 4. The other end 137a of the coil wire 137 is connected to an end 147a of the coil wire 147 of the SIN-coil fourth part 14B shown in FIG. 2 through the through hole 4a of the insulation layer 4. The other end 147b of the coil wire 147 is connected to an end 127b of the coil wire 127 of the SIN-coil second part 12B shown in FIG. 4 through the through hole 4a of the insulation layer 4. Thus, an outermost circumferential coil wire (117-137-147-127) is configured.

Further, the other end 127a of the coil wire 127 is connected to an end 116a of the coil wire 116 of the SIN-coil first part 11B through the through hole 4a of the insulation layer 4. As with the outermost circumferential coil wire (117-137-147-127), an outermost-but-one coil wire (116-136-146-126) is configured. Similarly, an outermost-but-two coil wire to an innermost circumferential coil wire (111-113-141-121) are respectively configured. Those coil wires 11A to 14A constitute a SIN signal detection coil 10B wound spirally clockwise.

An end 121a of the innermost circumferential coil wire (111-131-141-121) of the SIN signal detection coil 10B is connected to an end 121a of an innermost coil wire 121 of the SIN-coil second part 12A through the conductive wire 42b shown in FIG. 2, a conductive wire 42e shown in FIG. 4, and a conductive wire 42d shown in FIG. 2. The other end 121b of the coil wire 121 is connected to an end 141b of a coil wire 141 of the SIN-coil fourth part 14A through the through hole 4a of the insulation layer 4. The other end 141a of the coil wire 141 is connected to an end 131a of a coil wire 131 of the SIN-coil third part 13A through the through hole 4a of the insulation layer 4. The other end 131b of the coil wire 131 is connected to an end 111b of a coil wire 111 of the SIN-coil first part 11A through the through hole 4a of the insulation layer 4. Thus, an innermost circumferential coil wire (121-141-131-111) of a SIN signal detection coil 10A is configured.

The other end 111a of the coil wire 111 of the SIN-coil first part 11A is connected to an end 122a of a coil wire 122 of the SIN-coil second part 12A through the through hole 4a of the insulation layer 4. As with the innermost coil wire (121-141-131-111), an innermost-but-one coil wire (122-142-132-112) is configured. Similarly, an innermost-but-two coil wire to an outermost circumferential coil wire (127-147-137-117) are arranged. The above coils 11A to 14A constitute the SIN signal detection coil 10A would spirally counterclockwise by extending to and fro between the first coil layer 5 and the second coil layer 3.

Similarly, the coils 11C to 14C constitute a SIN signal detection coil 10C wound spirally counterclockwise and the coils 11D to 14D constitute a SIN signal detection coil 10D wound spirally clockwise. An end 117a of an outermost circumferential coil wire 117 of the SIN signal detection coil 10C is connected to the terminal 37 through a conductive wire 42e. In the above way, the four SIN signal detection coils 10A, 10B, 10C, and 10D constitute the SIN signal detection coil 10.

The COS signal detection coil 20 similarly includes four COS signal detection coils 20A, 20B, 20C, and 20D. The COS signal detection coil 20A includes a COS-coil first part 21A, a COS-coil second part 22A, a COS-coil third part 23A, a COS-coil fourth part 24A.

Herein, the COS-coil first part 21A and fourth part 24A are formed in the first coil layer 5 shown in FIG. 2, while the COS-coil second part 22A and third part 23A are formed in the second coil layer 3 shown in FIG. 4.

The COS signal detection coils 20B to 20D each have substantially the same configuration as that of the COS signal detection coil 20A.

The COS signal detection coil 20 is connected to terminals 34 and 38. Each of the COS signal detection coils 20A and 20C constitutes a coil wound spirally clockwise by extending to and fro between the first coil layer 5 and the second coil layer 3. Each of the COS signal detection coils 20B and 20D constitutes a coil wound spirally counterclockwise by extending to and fro between the first coil layer 5 and the second coil layer 3. The terminal 35 is connected to a terminal 36 through a stator-side rotary transformer 30 (31, 32).

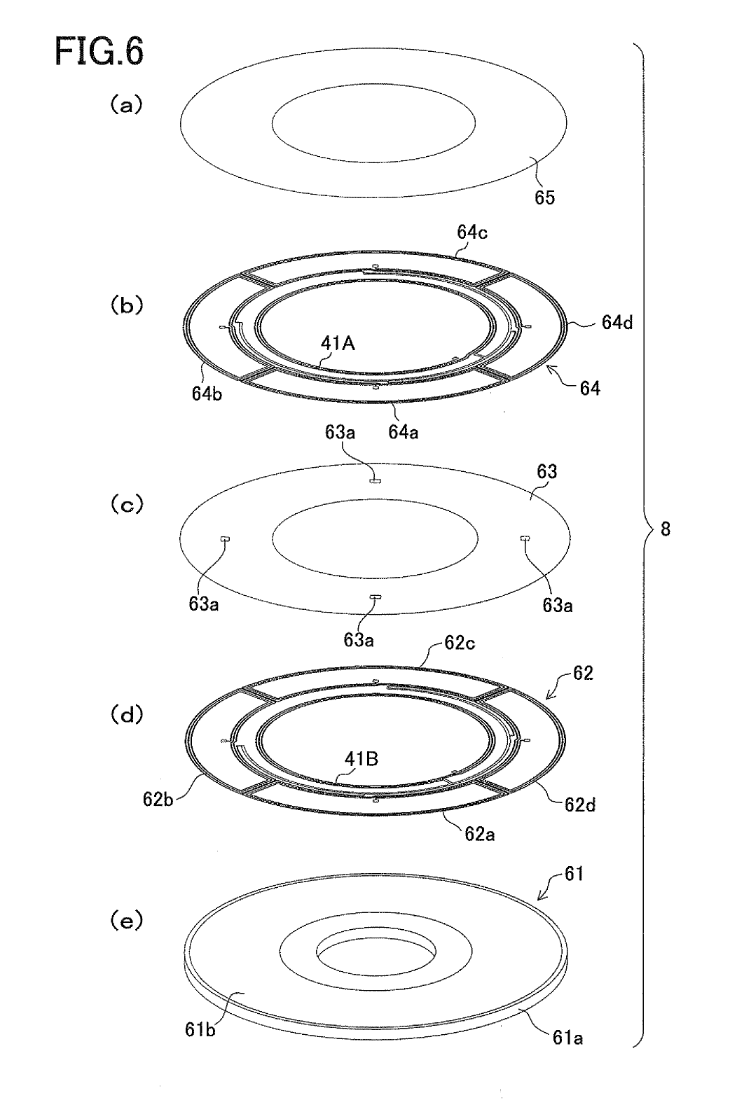

The following explanation is given to the resolver rotor 8 formed with the excitation coil 40. FIG. 6 is an exploded perspective view of the resolver rotor 8. In FIG. 6, (e) shows a resolver rotor body 61; (d) shows a first coil layer 62 formed on a surface of the body 61; (c) shows an interlayer insulation layer 63 that insulates between the first coil layer 62 and a second coil layer 64; (b) shows the second coil layer 64 formed on the insulation layer 63; and (a) shows an overcoat layer 65 made of insulation resin serving as a protective film. The interlayer insulation layer 63 is formed with through holes 63a (four holes in this embodiment).

The resolver rotor body 61 includes a plate 61a made of non-magnetic conductive metal, e.g., aluminum or brass, and formed like a circular disk having a central circular hole and a recessed surface. In the recessed surface, resin 61b such as PPS resin has been filled and solidified.

The first coil layer 62 includes four excitation coils 62a, 62b, 62c, and 62d. The second coil layer 64 includes four excitation coils 64a, 64b, 64c, and 64d. One ends of the coils 62a to 62d are connected to one end of a rotary transformer 41B. The other ends of the coils 62a to 62d are connected respectively to one ends of the excitation coils 64a to 64d of the second coil layer 64. The other ends of the excitation coils 64a to 64d are connected to one end of a rotary transformer 41A. The other end of the rotary transformer 41B and the other end of the rotary transformer 41A are connected to each other through the through hole 63a of the interlayer insulation layer 63.

The four excitation coils 62a to 62d of the first coil layer 62 and the four excitation coils 64a to 64d of the second coil layer 64 constitute the excitation coil 40.

An excitation signal generated in the excitation signal generator 51 is input to the excitation coil 40 via the stator-side rotary transformer 30 and the rotor-side rotary transformer 41 (41A and 41B).

A magnetic flux generated by the above excitation current generates an electromotive force (a detection signal) in the SIN signal detection coil 10 and the COS signal detection coil 20 on the stator side (the resolver stator 7). Amplitude variations of the electromotive force (the detection signal) generated in the SIN signal detection coil 10 and amplitude variations of the electromotive force (the detection signal) generated in the COS signal detection coil 20 are then subjected to analysis to calculate a rotational position (angle) of the resolver rotor 8.

Specifically, the first detection circuit 55 removes a high-frequency component of the excitation signal from the detection signal generated in the SIN signal detection coil 10. The second detection circuit 56 removes a high-frequency component of the excitation signal from the detection signal generated in the COS signal detection coil 20. The computing unit 57 calculates a current angle of the resolver rotor 8 based on a ratio in amplitude between the first detection circuit 55 and the second detection circuit 56 and outputs a calculated result in the form of angular data.

In the present embodiment, as mentioned above, the four excitation coils 62a to 62d and the rotary transformer 41B are formed in the first coil layer 62 while the four excitation coils 64a to 64d and the rotary transformer 41A are formed in the second coil layer 64. Accordingly, an occupied area of the excitation coil 40 and the rotary transformer in one coil layer is small, so that the resolver 9 can have small external dimensions.

As explained in detail above, the resolver 9 of the present embodiment includes the SIN coil and the COS coil each formed on the flat plate, in which the first coil layer 5 and the second coil layer 3 are formed in the flat plate, and the insulation layer 4 is formed between the first coil layer 5 and the second coil layer 3. The SIN signal detection coil 10 is divided into two parts in the circumferential direction and further into two parts in the radial direction so that the SIN-coil first part 11 and second part 12 are arranged on the outer circumferential side and the SIN-coil third part 13 and fourth part 14 are arranged on the inner circumferential side. The SIN-coil first part 11 and the SIN-coil third part 13 are arranged in the same position (range) in the circumferential direction and to face each other in the radial direction and the SIN-coil second part 12 and the SIN-coil fourth part 14 are arranged in the same position (range) in the circumferential direction and to face each other in the radial direction. The SIN-coil first part 11 and the SIN-coil fourth part 14 are placed in the first coil layer 5 and the SIN-coil second part 12 and the SIN-coil third part 13 are placed in the second coil layer 3. The COS signal detection coil 20 is divided into two parts in the circumferential direction and further into two parts in the radial direction so that the COS-coil first part 21 and second part 22 are on the outer circumferential side and the COS-coil third part 23 and fourth part 24 are arranged on the inner circumferential side. The COS-coil first part 21 and the COS-coil third part 23 are arranged in the same position (range) in the circumferential direction and to face each other in the radial direction and the COS-coil second part 22 and the COS-coil fourth part 24 are arranged in the same position (range) in the circumferential direction and to face each other in the radial direction. The COS-coil first part 21 and the COS-coil fourth part 24 are placed in the first coil layer 5 and the COS-coil second part 22 and the COS-coil third part 23 are placed in the second coil layer 3. With the above configuration, even when the resolver body 1 itself is deformed, e.g., undulated, the SIN-coil first part 11 (the SIN-coil fourth part 14) and the SIN-coil second part 21 (the SIN-coil third part 13) cancel out the errors generated by the deformation such as undulation while the COS-coil first part 21 (the COS-coil fourth part 24) and the COS-coil second part 22 (the COS-coil third part 23) cancel out the errors generated by the deformation such as undulation. Therefore, the resolver 9 can provide high accuracy.

Specifically, the SIN-coil first part 11 is present in the first coil layer 5, the SIN-coil second part 12 is present in the second coil layer 3, the SIN-coil third part 13 is present in the second coil layer 3, and the SIN-coil fourth part 14 is present in the first coil layer 5. Accordingly, even if the SIN-coil first part 11 and fourth part 14 in the first coil layer 5 and the SIN-coil second part 12 and third part 13 in the second coil layer 3 receive different magnetic flux densities due to a gap which changes due to the deformation in the circumferential direction, the entire SIN signal detection coil 10 (SIN-coil parts 11, 12, 13, 14) can cancel the errors.

Similarly, the COS-coil first part 21 is present in the first coil layer 5, the COS-coil second part 22 is present in the second coil layer 3, the COS-coil third part 23 is present in the second coil layer 3, and the COS-coil fourth part layer 24 is present in the first coil layer 5. Even if the COS-coil first part 21 and fourth part 24 in the first coil layer 5 and the COS-coil second part 22 and third part 23 in the second coil layer 3 receive different magnetic flux densities due to a gap which changes by the deformation in the circumferential direction, the entire COS signal detection coil 20 (COS-coil parts 21, 22, 23, 24) can cancel the errors.

A pair of the SIN-coil first part 11 and third part 13 and a pair of the COS-coil second part 22 and fourth part 24 are located in the same position in the circumferential direction. A pair of the SIN-coil second part 12 and fourth part 14 and a pair of the COS-coil first part 21 and third part 23 are located in the same position in the circumferential direction. Accordingly, a positional relationship between the SIN signal detection coil 10 and the COS signal detection coil 20 can be always constant with respect to the excitation coil 40.

Furthermore, the SIN-coil first part 11 and the SIN-coil second part 12 are connected to each other through the through hole 4a of the insulation layer 4. The SIN-coil second part 12 and the SIN-coil fourth part 14 are connected to each other through the through hole 4a of the insulation layer 4. The SIN-coil fourth part 14 and the SIN-coil third part 13 are connected to each other through the through hole 4a of the insulation layer 4. The SIN-coil third part 13 and the SIN-coil first part 11 are connected to each other through the through hole 4a of the insulation layer 4. The COS-coil first part 21 and the COS-coil second part 22 are connected to each other through the through hole 4a of the insulation layer 4. The COS-coil second part 22 and the COS-coil fourth part 24 are connected to each other through the through hole 4a of the insulation layer 4. The COS-coil fourth part 24 and the COS-coil third part 23 are connected to each other through the through hole 4a of the insulation layer 4. The COS-coil third part 23 and the COS-coil first part 21 are connected to each other through the through hole 4a of the insulation layer 4. With the above configuration, the detection coil (10 and 20) can be easily manufactured with high positional accuracy. Thus, even if the received magnetic flux densities are different between the coils due to the gaps resulting from the deformation in the circumferential direction, the entire SIN signal detection coil 10 (SIN-coil first to fourth parts 11 to 14) can cancel the errors reliably and precisely.

The first coil layer 5 and the second coil layer 3 are formed in such a way that respective coil patterns are drawn by printing with conductive ink and then subjected to burning. Even if the first coil layer 5 and the second coil layer 3 have a deviation due to the burning process, the above configuration can average respective resistance values of the SIN signal detection coil 10 and the COS signal detection coil 20, so that the resistance values are canceled each other. Thus, detection accuracy is less likely to deteriorate.

The SIN signal detection coil 10 and the COS signal detection coil 20 constitute a detection coil (10+20). Accordingly, the resolver 9 can generate a constant induced voltage to a predetermined magnetic field and thus achieve high accuracy.

The present invention is not limited to the above embodiment and may be embodied in other specific forms without departing from the essential characteristics thereof.

In the above embodiment, the SIN-coil first part 11 and fourth part 14 are formed in the first coil layer 5 and the SIN-coil second part 12 and third part 13 are formed in the second coil layer 3. As an alternative, it may be arranged that the SIN-coil first part 11 and fourth part 14 are formed in the second coil layer 3 and the SIN-coil second part 12 and third part 13 are formed in the first coil layer 5.

In the above embodiment, similarly, the COS-coil first part 21 and fourth part 24 are formed in the first coil layer 5 and the COS-coil second part 22 and third part 23 are formed in the second coil layer 3. As an alternative, it may be arranged that the COS-coil first part 21 and fourth part 24 are formed in the second coil layer 3 and the COS-coil second part 22 and third part 23 formed in the first coil layer 5.

Although the above embodiment explains a one-ii and two-output resolver, the present invention may also be applied to a two-ii and one-output resolver.

### DESCRIPTION OF THE REFERENCE SIGNS

3 Second coil layer
5 First coil layer
7 Resolver stator
8 Resolver rotor
9 Resolver
10 SIN signal detection coil
11 SIN-coil first part
12 SIN-coil second part
13 SIN-coil third part
14 SIN-coil fourth part
20 COS signal detection coil
21 COS-coil first part
22 COS-coil second part
23 COS-coil third part
24 COS-coil fourth part
31, 32 Stator-side rotary transformer
40 Excitation coil
41 Rotor-side rotary transformer
58 Circuit
59 Sensor section
70 Motor

1. A resolver having a SIN coil and a COS coil each formed on a flat plate, the resolver including a first coil layer and a second coil layer each formed on the flat plate, and an insulation layer formed between the first coil layer and the second coil layer,
wherein the SIN coil is divided into two parts in a circumferential direction and further two parts in a radial direction so that a SIN-coil first part and a SIN-coil second part are arranged on an outer circumferential side and a SIN-coil third part and a SIN-coil fourth part are arranged on an inner circumferential side,
the SIN-coil first part and the SIN-coil third part are arranged in the same position in the circumferential direction and to face each other in a radial direction and the SIN-coil second part and the SIN-coil fourth part are arranged in the same position in the circumferential direction and to face each other in the radial direction,
the SIN-coil first part and the SIN-coil fourth part are placed in the first coil layer and the SIN-coil second part and the SIN-coil third part are placed in the second coil layer,
the COS coil is divided into two parts in the circumferential direction and further into two parts in the radial direction so that a COS-coil first part and a COS-coil second part are arranged on an outer circumferential side and a COS-coil third part and a COS-coil fourth part are arranged on an inner circumferential side,
the COS-coil first part and the COS-coil third part are arranged in the same position in the circumferential direction and to face each other in the radial direction and the COS-coil second part and the COS-coil fourth part are in the same position in the circumferential direction and to face each other in the radial direction, and
the COS-coil first part and the COS-coil fourth part are placed in the first coil layer, and the COS-coil second part and the COS-coil third part are placed in the second coil layer.

2. The resolver according to claim 1, wherein a pair of the SIN-coil first part and the SIN-coil third part and a pair of the COS-coil second part and the COS-coil fourth part are located in the same position in the circumferential direction, and a pair of the SIN-coil second part and the SIN-coil fourth part and a pair of the COS-coil first part and the COS-coil third part are located in the same position in the circumferential direction.

3. The resolver according to claim 1,
wherein the SIN-coil first part and the SIN-coil second part are connected through a through hole formed in the insulation layer,
the SIN-coil second part and the SIN-coil fourth part are connected through the through hole of the insulation layer,
the SIN-coil fourth part and the SIN-coil third part are connected through the through hole of the insulation layer,
the SIN-coil third part and the SIN-coil first part are connected through the through hole of the insulation layer,
the COS-coil first part and the COS-coil second part are connected through the through hole of the insulation layer,
the COS-coil second part and the COS-coil fourth part are connected through the through hole of the insulation layer,
the COS-coil fourth part and the COS-coil third part are connected through the through hole of the insulation layer, and
the COS-coil third part and the COS-coil first part are connected through the through hole of the insulation layer.

4. The resolver according to claim 2,
wherein the SIN-coil first part and the SIN-coil second part are connected through a through hole formed in the insulation layer,
the SIN-coil second part and the SIN-coil fourth part are connected through the through hole of the insulation layer,
the SIN-coil fourth part and the SIN-coil third part are connected through the through hole of the insulation layer,
the SIN-coil third part and the SIN-coil first part are connected through the through hole of the insulation layer,
the COS-coil first part and the COS-coil second part are connected through the through hole of the insulation layer,
the COS-coil second part and the COS-coil fourth part are connected through the through hole of the insulation layer,
the COS-coil fourth part and the COS-coil third part are connected through the through hole of the insulation layer, and
the COS-coil third part and the COS-coil first part are connected through the through hole of the insulation layer.

5. The resolver according to claim 1, wherein each of the first coil layer and the second coil layer is formed by in such a way that a predetermined pattern is drawn by printing with conductive ink and then subjected to burning.

6. The resolver according to claim 2, wherein each of the first coil layer and the second coil layer is formed by in such a way that a predetermined pattern is drawn by printing with conductive ink and then subjected to burning.

7. The resolver according to claim 1, wherein the SIN coil and the COS coil form a detection coil.

8. The resolver according to claim 2, wherein the SIN coil and the COS coil form a detection coil.
